(19) United States
(12) Patent Application Publication
(10) Pub. No.: US 2002/0065699 A1
(43) Pub. Date: May 30, 2002

(54) General discrete choice model and optimization algorithm for revenue management

(76) Inventor: Kalyan Talluri, Barcelona (ES)

Correspondence Address: William A. Blake, Jones, Tullar & Cooper, P.C., Eads Station, P.O. Box 2266, Arlington, VA, 22202, US

(21) Appl. No.: 09/950,812

(22) Filed: Sep. 13, 2001

Related U.S. Application Data
(60) Provisional application No. 60/232,620, filed on Sep. 14, 2000.

(51) Int. Cl. G06F 17/60

(52) U.S. Cl. 705/8

(57) ABSTRACT

A discrete choice model of consumer demand is employed to generate controls to limit or open up availability of inventory of a resource, for example, thereby improving the revenue of a firm offering the resource for sale. The consumer's choice process is modeled as a set of choice probabilities that depend on what alternatives are available at that moment. An optimization algorithm is preferably employed for determining what choices to offer for sale at any point of time in a pricing or revenue management system. An estimation algorithm that is preferably used with the choice model for estimating the size of the potential customer base and estimating the price and product attribute value sensitivity of customers based solely on historical and transactional data (hypothesizing as unobservable, customer no-purchases).

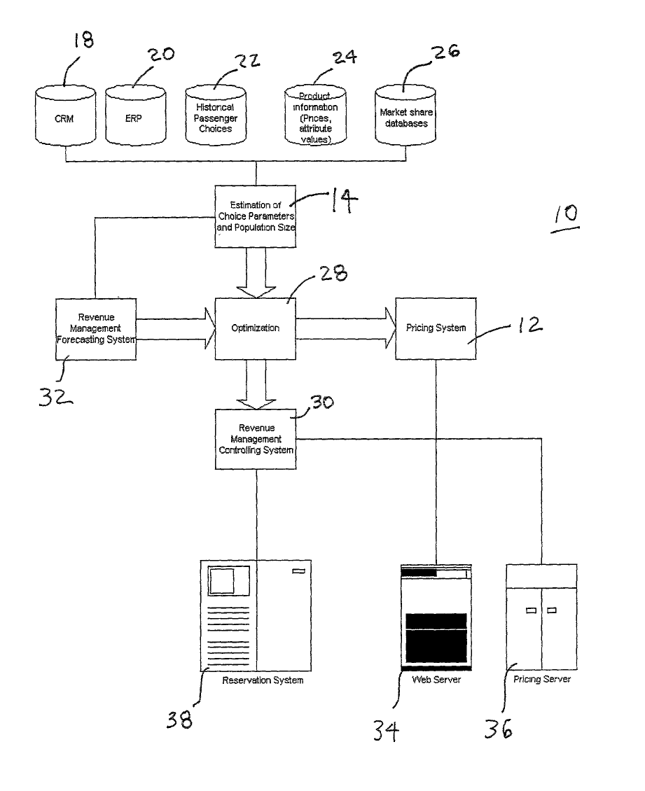

### PRIORITY CLAIM UNDER 35 USC 119 (e)

This application claims the benefit, under 35 USC 119(e), of U.S. Provisional Application. No. 60/232,620, filed Sep. 14, 2000, which is hereby incorporated by reference.

### BACKGROUND OF THE INVENTION

1. Field of the Invention

The present invention relates in general to a revenue management system (also referred to as “yield management” system) for allocating resources or inventory. The customer purchase behavior is modeled as making a discrete choice among a set of alternatives at the moment of booking or purchase and an optimization algorithm using the choice modeling to allocate the resources is given. A method for the estimation of the parameters of the model is also included. The model, the algorithm and the estimation procedures are innovations that lead to substantially better revenues for the seller of the inventory.

2. Description of the Background Art

Revenue management systems seek to maximize the revenue generated from a fixed service or productive capacity by selectively accepting or denying requests for capacity. For example, in airlines a network of flights with a set of seats are available for sale on a given day, and customers request seats in advance of travel for various itineraries on the network. Based on the current reservations already accepted for each flight (alternatively, the remaining capacity available), the time remaining in the sales horizon and forecasts of future demand for itineraries, airlines must decide which itineraries and fare classes to accept and which to deny (or close out).

These decisions are very detailed and complicated to make because future demand is typically highly uncertain and one must evaluate complex tradeoffs between the current and future value of capacity. Therefore, revenue management decisions are typically made (or guided by) a software system (revenue management system) that incorporate a variety of advanced statistical and mathematical methods. Revenue management is widely used in the airline, hotel and car-rental industries and is spreading to the energy, natural gas pipelines, broadcasting, shipping, sports, entertainment facilities, manufacturing, logistics, wireless, equipment leasing and cargo industries. Indeed, the practice is applicable in any industry that has limited short-term capacity flexibility and variable demand.

A variety of mathematical models have been proposed to solve the problem of which requests to accept or deny based on current capacity and forecasts of future demand. General references to revenue management in the area of airline seat sales or bookings can be found in the following publications: 1) K. Littlewood, “Forecasting and control of passenger bookings,” Proceedings of the 12^{th} AGIFORS Symposium, pp. 95-117, October 1972; 2) P. P. Belobaba, “Airline yield management, an overview of seat inventory control,” Transportation Science vol 21, pp. 63-72, 1987; 3) P. P. Belobaba, “Application of a probabilistic decision model to airline seat inventory control,” Operations Research, vol 37, pp. 183-197, 1989; 4) S. L. Brumelle and J. I. McGill “Airline Seat Allocation With Multiple Nested Fare Classes,” Operations Research, vol 41, pp. 127-137, 1993; 5) S. L. Brumelle, J. I. McGill, T. H. Oum, K. Sawaki and M. W. Tretheway “Allocation of Airline Seats between Stochastically Dependent Demands,” Trans. Science, vol. 24, pp. 183-192, 1990; 6) B. Smith, B., J. Leimkuhler, R. Darrow, and J. Samuels, “Yield Management at American Airlines,” Interfaces, vol. 22, pp. 8-31, 1992; 7) E. L. Williamson, “Airline Network Seat Inventory Control: Methodologies and Revenue Impacts,” Doctoral Dissertation, Flight Transportation Laboratory, MIT, Cambridge, Mass., 1992; 8) B. Vinod, “Reservation Inventory Control Techniques to Maximize Revenue,” Proceedings of the Third International Airline Yield Management Conference, London, Dec. 3, 1990; 9) R. W. Simpson, “Using Network Flow Techniques to Find Shadow Prices for Market Demands and Seat Inventory Control,” Flight Trans. Lab Memorandum M89-January 1989; 10) R. E. Curry, “Real-Time Revenue Management—Bid Price Strategies for Origins/Destinations and Legs,” Scorecard, Second Quarter 1992, Aeronomics Inc. Publication; and 11) R. L. Phillips, “A Marginal-Value Approach to Airline Origin-Destination Revenue Management,” Proceedings of the 16^{th} IFIP Conference on Systems Modeling and Optimization,” J. Henry and J. P. Yvon (ed.), Springer Verlag, New York, 1994.

Despite the success of this body of work, most of the above-mentioned models make a common, simplifying—and potentially problematic—assumption; namely, that consumer demand for each of the fare classes is completely independent of the controls being applied by the seller. That is, the problem is modeled as one of determining which exogenously arriving requests to accept or reject, and it is assumed that the likelihood of receiving a request for any given fare class does not depend on which other fares are available at the time of the request. However, casual observation—and a brief reflection on one's own buying behavior as a consumer—suggests that this is not the case in reality. The likelihood of selling a full fare ticket may very well depend on whether a discount fare is available at that time; the likelihood that a customer buys at all may depend on the lowest available fare, etc. Clearly, such behavior could have important revenue management consequences and should be considered when making control decisions.

Belobaba and Weatherford (P. P. Belobaba, L. R. Weatherford, “Comparing Decision Rules that Incorporate Customer Diversion in Perishable Asset Revenue Management Solutions,” Decision Sciences, vol 27, 2, pp. 343-363, 1996) proposed a correction to the EMSR heuristics that introduces a probability of buying a higher fare when a low fare is closed. While conceptually appealing for a two-fare-class model, such pair-wise “buy-up” probabilities are problematic in a multiple-fare-class setting. The probability of buying a given high fare should depend on which other high fares are also available. Also, one cannot directly observe “buy-up”, so how does one separate “original” sales from “buy-up” sales? No estimation procedure is given. Moreover, the product features do not influence the buy-up probability. Andersson (S. E Andersson, “Passenger Choice Analysis for Seat Capacity Control: A Pilot Project in Scandinavian Airlines,” Intl. Trans. Opl. Res., 5, 471-486, 1998) does develop an estimation procedure for this buy-up probabilities based on a specific logit model, but their usage is still limited to using a heuristic based on a 2-fare class formula.

To summarize, most of the prior art on revenue management completely ignores passenger or consumer behavior and assumes an unrealistic model of passenger demand in which demand comes independently for each fare class and if a fare class is closed, the demand disappears. The few works (cited above) that try to overcome this limitation do not present a realistic demand model where customers evaluate different alternatives and that is exogenous of the revenue management system of the firm offering the seats or other resource. Nor do they present an optimization and control system that optimizes the firm's revenue based on the demand model.

### SUMMARY OF THE INVENTION

In view of the foregoing, the present invention is directed first toward a computer implemented revenue management method and system in which consumer behavior is explicitly modeled using what is referred to as a discrete choice model of consumer demand, and the model is employed to generate controls to limit or open up availability of inventory of a resource, for example, thereby improving the revenue of a firm offering the resource for sale.

More particularly, the consumer is modeled as wanting to purchase one or more units of the inventory (typically perishable with a fixed or soft deadline—for example airline seats or hotel room stay) from a firm and at around the time of this wish-to-purchase, evaluating the different alternatives (either from the firm or from competitors offerings) and the attributes (restrictions, penalties, price) of the alternatives, and then, based on this evaluation, deciding to purchase units of one of the available alternatives or deciding not to purchase any of the firm's products. The consumer's choice process is modeled as a set of choice probabilities that depend on what alternatives are available at that moment. Different sets of alternatives would lead to different choice probabilities. No assumptions or restrictions are placed on these sets of choice functions. The model therefore includes every choice model of practical interest as no specific functional form is assumed on how the probabilities change as different sets of products are offered for sale.

The firm can increase it's revenue by gaining a more precise understanding of the parameters of its choice model (either of a functional form or the choice probability sets themselves) and then using this information to guide the sale of its products at different purposes. A recursive optimization algorithm is thus preferably employed to define how the firm should optimize its inventory sales based on estimates of customer preferences and purchase behavior. Performing revenue management this way, instead of assuming independent demands or using “buy-up” factors can lead to significant improvement in the firm's revenues as shown in studies in Talluri and Van Ryzin (K. Talluri and G. van Ryzin. “Revenue Management under a General Discrete Choice Model of Demand”, Working Paper, Universitat Pompeu Fabra, 2001).

Another key feature of the invention is an estimation algorithm that is preferably used with the choice model, and estimates and forecasts the parameters of the model accounting for both observable characteristics and non-observable information. The estimation procedure carried out by the algorithm explicitly accounts for private unobservable information and behavior on the part of the consumer in the revenue management context. More particularly, the estimation algorithm makes estimates of “no-purchase” consumer behavior data, which represents the likelihood that given a set of resource choices at a given moment, a consumer will simply decide not to purchase any units of inventory at all. Preferably, the estimation algorithm employs a conventional expectation-maximization (EM) method to generate the estimates of these unknown parameter values.

The invention has applications in any industry where dynamic pricing decision support can be applied for the sale of an inventory of goods or services. Such industries include but are not limited to: airlines, hospitality (hotels, cruise-lines etc.), railways, rental-car, manufacturing, logistics, retail, utilities, telecommunications and wireless service providers, health-care, B2B marketplaces. In addition, customer information residing in internal, proprietary or CRM (Customer Relationship Management) databases can be used by this model to predict demand elasticities as well as recommend the choices to offer to each customer.

The discrete choice model and estimation algorithm can also be used in a pricing system, for example, for providing a firm with the ability to analyze how changes in the various attributes of a resource affect demand for the resource. More particularly, the estimation algorithm, which accounts for unobservable no-purchases as discussed previously, can be used for estimating customer preferences to product attributes (including but not limited to, price, day of utilization, time of utilization, penalties, minimum and maximum stay restrictions) defined as the rate at which demand changes as a function a change in one of the parameter values. In this embodiment of the invention, the optimization algorithm would not be employed since there is no revenue management system to control.

### BRIEF DESCRIPTION OF THE DRAWINGS

The features and advantages of the present invention will become apparent form the following detailed description of a number of preferred embodiments thereof, taken in conjunction with the accompanying drawing figure which is a block diagram illustrating a pricing and revenue management system, and its operational flow, for implementing the preferred embodiments of the present invention.

### DETAILED DESCRIPTION OF THE PREFERRED EMBODIMENTS

Turning now to a detailed description of the preferred embodiments of the invention, the sole drawing figure illustrates a pricing and revenue management system 10 that can be employed, for example, to manage sale of a number of units of inventory of a resource, or to determine relationships between price changes and demand. The resource can be any item or product that has limited short-term capacity flexibility and variable demand, such as airline seats, hotel rooms, car rentals, seats at sports or entertainment events, commodities, etc. The system 10 includes a pricing system 12 that determines prices of the inventory units based on a number of factors. To do this, the pricing system 12 runs an estimation algorithm that determines the values of a number of parameters in a discrete choice model of consumer demand as illustrated at 14. The estimation algorithm is so named because some of the parameters of the choice model are unobservable and must be estimated from other known parameter values. More particularly, customer “no-purchases,” which represent occurrences where a potential customer evaluates the inventory units and decides not to purchase any of them, are estimated from the known values, such as customer population size. A correction for the no-purchases can then be made to improve the accuracy of the model. To obtain the known parameter values, the estimation algorithm receives input data from any of a number of possible sources, including a CRM (Customer Relationship Management) database 18, an ERP (Enterprise Resource Planning) database 20, a database 22 of historical passenger choices, a product information database 24 containing prices and attribute values for each offered product and one or more market share databases 26 containing firm market performance information.

An optimization algorithm as indicated at 28 is preferably provided for generating control values to be employed by a revenue management controlling system 30, which sets choices, prices and other attributes of the units of a resource to be offered for sale, for example. It will be understood that the optimization algorithm is optional in a revenue management system, and would not be employed if only the pricing system 12 were implemented in the system 10. The optimization algorithm receives input data from the estimation algorithm and from a revenue management forecasting system 32, which is preferably provided to predict future revenues based on the estimates generated by the estimation algorithm.

Other elements of the system 10 include a Web server 34, a pricing server 36 and a reservation system 38, each of which are computer systems that facilitate ancillary functions, including Internet access to the system 10, delivery and storage of resource unit pricing information and processing of reservations for resource units.

Discrete Choice Model

The discrete choice model can take a number of forms, and provided herein is one preferred embodiment of a suitable choice model. In the model, time is discrete and indexed by t, and the indices run backwards in time (e.g. smaller values of t represent later points in time). That is, time 0 represents the deadline for the sale of units (This perishability of the inventory units is a typical characteristic of revenue management applications). In each period there is at most one arrival. The probability of arrival is denoted by π, which we assume is the same for all time periods t.

(Extending the results to time-varying arrival probabilities is straightforward but cumbersome; we omit the details to simplify the exposition.) There are n fare products and N={1, . . . ,n} denotes the entire set of fare products. Each fare product jεN has an associated revenue rⱼ, and without loss of generality we index fare products so that r₁≧R₂ r₂≧. . . ≧rₙ≧0.

In each period t, the firm must choose a subset S [symbol] N of fare products to offer. When the fares S are offered, the probability that a customer chooses class j ε S is denoted P_{J}(S) and we assume Pⱼ(S)=0 if j ε S. We let j=0 denote the no-purchase choice; that is, the event that the customer does not purchase any of the fares offered in S. P₀(S) denotes the no-purchase probability. We can allow the choice probabilities to be a function of time t as well, but to keep the notation simple we will assume that the probabilities do not depend on time. The probability that a sale of class j is made in period t is therefore λ P_{J}(S), and the probability that no sale is made is λ P₀(S)+(1−λ). (Note this last expression reflects the fact that having no sales in a period could be due either to no arrival at all or an arrival that does not purchase; as mentioned, this leads to an incomplete data problem in practice.)

The only conditions we impose on the choice probabilities P_{J}(S) it that they define a proper probability function. That is, for every set S [symbol] N, the probabilities satisfy

$${P}_{j} ( S ) \geq 0 for all j ε S and {\sum }_{j ε S} {P}_{j} ( S ) + {P}_{0} ( S ) = 1.$$

This includes most all choice models of interest as no assumptions are made on Pⱼ(S). For illustration purposes, we give below as an example, the multinomial-logit (MNL) as generating the choice probabilities:

The MNL is used widely in travel demand forecasting and marketing (see M. Ben-Akiva and S. R. Lerman, “Discrete Choice Analysis”, The MIT Press, Cambridge, Mass.). In the MNL, consumers are utility maximizers and the utility of each choice is a random variable. Formally, the utility of each alternative $j$ is assumed to be of the form U_{J}=u_{J}+χ_{J}, where u_{J} is the mean utility of choice j and χ_{J} is an i.i.d., Gumbel random noise term with mean zero and scale parameter one for all j. Because utility is an ordinal measure, the assumption of zero mean and a scale parameter of one are without loss of generality (see Ben-Akiva and Lerman). Similarly, there is a no-purchase option where the no-purchase utility is assumed to be U₀=u₀+χ₀ where χ₀ is also Gumbel with mean zero and scale parameter one. Again, since utility is ordinal, without loss of generality we can assume u₀=0.

Under this utility model, one can show (See Ben-Akiva and Lerman for a derivation.) that the choice probabilities are given by

$${P}_{j} ( S ) = \frac{{e}^{{u}_{j}}}{{\sum }_{i ε S} {e}^{{u}_{j}} + {e}^{{u}_{0}}} j ε S or j = 0$$

and zero otherwise. For notational convenience, we define “weights” w_{J}=e^{u}_{^{J}}, j=0,1, . . . , n.

Optimizing Algorithm

We next formulate a single-leg problem based on the general choice model. Let C denote the total inventory capacity for sale for a resource, T denote the number of time periods, t denote the number of remaining periods (recall time is indexed backwards) and x denotes the number of remaining inventory units. Define the value function Vₜ (x) as the maximum expected revenue obtainable from periods t,t−1 , . . . ,1 given that there are x inventory units remaining at time t. Then the optimal equation for Vₜ (x) is

$${V}_{i} ( x ) = {max}_{S ⊆ N} \{ {\sum }_{j ε S} λ {P}_{j} ( S ) ( {r}_{j} + {V}_{t - 1} ( x - 1 ) ) + ( λ {P}_{0} ( S ) + 1 - λ ) {V}_{t - 1} ( x ) \}$$

with boundary conditions

Vₜ(0)=0,t=1, . . . ,t and V₀(x)=0,x=1, . . . ,C

We can write the above recursion in more compact form as

$${V}_{t} ( x ) = {max}_{S ⊆ N} \{ λ ( R ( S ) - Q ( S ) ∇ {V}_{t - 1} ( x ) \} + {V}_{t - 1} ( x )$$

where

∇Vₜ₋₁(x)+Vₜ₋₁(x)−Vₜ₋₁(x−1)

and

$$Q ( S ) = {\sum }_{j ∈ S} {P}_{j} ( S ) = 1 - {P}_{0} ( S )$$

denotes the total probability of purchase and

$$R ( S ) = {\sum }_{j ∈ S} {P}_{j} ( S ) {r}_{j}$$

denotes the total expected revenue from offering set S.

A sequence of sets achieving the maximum in the above recursions forms an optimal solution.

We will also consider allowing the seller to randomize over the sets S that are offered at the beginning of each time period. Since the number of subsets is finite, there is always one set S that maximizes π(R(S)−Q(S)∇Vₜ₋₁(x)) (there may be ties or course), so randomizing among the sets to offer provides no additional benefit to the seller (at most they can randomize between two or more optimal sets and achieve the same revenue as using one of the optimal sets alone). However, allowing this flexibility in policies will be useful theoretically.

Potentially, each optimization could require an evaluation of all 2ⁿ subsets. However, it is shown in Talluri and Van Ryzin that the search can be reduced to an evaluation of only nondominated sets. These sets are defined as follows:

A set Tis said to be dominated if there exist probabilities

$$α ( S ) , ∀ S ⊆ N with {\sum }_{S ⊆ N} α ( S ) = 1$$

such that either

$$Q ( T ) > {\sum }_{S ⊆ N} α ( S ) Q ( S ) and R ( T ) \leq {\sum }_{S ⊆ N} α ( S ) R ( S )$$

$$or$$

$$Q ( T ) \geq {\sum }_{S ⊆ N} α ( S ) Q ( S ) and R ( T ) < {\sum }_{S ⊆ N} α ( S ) R ( S )$$

A set is said to be nondominated if it is not dominated.

In words, a set T is dominated if we can use a randomization of other sets S to produce an expected revenue that is strictly greater than R(T) with no increase in the probability of purchase Q(T) (or the same revenue R(T) with a probability strictly lower than Q(T)). It is further shown in Talluri and Van Ryzin that both the independent demand model and logit model, the nondominated sets are of the form: {1},{1,2},{1,2,3}, . . . , {1,2, . . . , n}, i.e. nested by fare values. Therefore for these two types of choice probabilities (there could be many others), a bid-price control (which uses a threshold value to evaluate whether to accept or reject bookings) can be used.

The optimization method for finding the optimal subsets of fare products to offer is therefore as follows:

1) Divide the purchase period into a number of intervals such that the probability of a purchase is very small (<1.0)

2) Calculate the choice probabilities as a function of the collection of fare products that may be offered (either by a functional form or using a oracle black-box).

3) Calculate the values of the revenue function at each point of time and each value of remaining inventory as given in the recursion above.

4) Use the values of V and ∇V either in an allocation scheme or a threshold value reservation and sale control.

An example program illustrates this method using a logit type choice probabilities and one attribute (price).

ChoiceDP (Idx_t legIdx, Idx_t nFcls, Float_t fares [] , Float_t coeff, Float_t
popSize, Idx_t cap, Idx_t allocs [])
{
//Example of an implementation of the optimization method with 1 attribute
(price)
// popSize is an estimate of the population size
//cap is the total amount of inventory for sale
//nFcls is the number of fare products
//legIdx is the index of the leg resource being optimized

Idx_t i,j,k,l,m,nPeriods,i2;
Float_t *V,*temp,*deltaV,denom,frac,max,popS,x,y;
float **probs;
ARY_INIT_ZERO (allocs,nFcls,SIZE_I) ;
MEM_ALLOC (V, (Float_t *), (cap+1) *SIZE_F) ;
MEM_ALLOC (temp, (Float_t *), (nFcls) *SIZE_F) ;
MEM_ALLOC (deltaV, (Float_t *), (cap+1) *SIZE_F) ;
//stores the probabilities for each choice set with the first k fareclasses
probs=matrix (0,nFcls-1,0,nFcls-1) ; //
ARY_INIT_ZERO (V, (cap+1), SIZE_F) ;
ARY_INIT_ZERO (deltaV, (cap+1), SIZE_F) ;
//calculate the probabilities from the coefficient
for (i=0;i<nFcls;i++) {

for (j=0,denom=1.0;j<=i;j++) denom+=exp (coeff*fares [j]) ;
for (j=0;j<=i;j++)

probs [i] [j] =exp (coeff*fares [j]) /denom; //example logit

}
for (j=0,x=0.0;j<nFcls;j++) x+= (y=exp (coeff*fares [j])) ;
popS=popSize* (x/ (x+1.0)) *gl_EVT_currTime/HorizonT;
nperiods=(int) 2*popS+1;
frac=popS/nPeriods;
//DP loop
for (1=0;i<nPeriods;i++) {

for (l=1;l<=cap;l++) {

ARY_INIT_ZERO (temp,nFcls,SIZE_F) ;
for (j=0,max=−INF;j<nFcls;j++) {

for (k=0;k<=j;k++) {

x=frac*probs [j] [k] ;
temp [j] +=frac*probs [j] [k] * (fares [k] −deltaV [l]) ;

}
if (temp [j] >max) {

m=j;
max=temp [j] ;

}

}
V [l] +=max; //add to the previous period's value function

}
for (l=cap;l>0;l−−) deltaV [l]=V [l]−V [l−1] ;

}
//set the allocations based on deltaV for the last period
for (j=1,m=1;j<nFcls;j++) {

for (i=m;i<=cap;i++) {

if (fares [j] >=deltaV [i]) {

allocs [j] =cap+1−i;
m=i;
break;

}

}

}
for (j=0;j<=m;j++) allocs [j] =cap;
FREE_matrix (probs,0,nFcls−1,0,nFcls−1) ;
FREE (temp) ;
FREE (deltaV) ;
FREE (V) ;

RETURN:
}

Estimation Algorithm

We next give a method for estimating choice model parameters from historical data. We will use the MNL model for illustration, but any other functional form can be used. To estimate the mean utility, it is common to model it as a linear function of several known attributes (e.g., price, indicator variables for product restrictions, etc.), much as one would do in a linear regression model. Thus, we assume u_{J}=β^{T}x_{J} where x_{J} is a vector of known attributes of choice j and β is a vector of weights on these variables. The weights β are to be estimated from historical data.

While we focus on the MNL case, the basic ideas developed below work with essentially any choice model for which maximum likelihood methods can be applied.

Estimation of the MNL model given a complete set of choice data is a well-studied problem. In particular, the maximum likelihood estimate (MLE) has good computational properties (Its log is jointly concave in most cases; and the method has proved robust in practice. (See Ben-Akiva and Lerman.)

In our case, we have an arrival probability as well as choice parameters to estimate. Given complete observations, estimation for our model is only a slight modification of the MNL case. In particular, let D denote a set of intervals, indexed by t, in which independent arrival events and choice decisions have been observed. The set D could combine intervals from many flight departures and, deviating somewhat from our notational convention thus far, there does not necessarily represent the time remaining for a particular flight.

For each period t ε D let

$${a}_{t} = \{ \begin{matrix}1 & if customer arrives in period t \\ 0 & otherwise\end{matrix}$$

Let A denotes the set of periods t with arrivals (aₜ=1) and \overline{A}=D−A denote the periods with no arrivals. If \overline{A}=D−A let j(t) denote the choice made by the arriving customer. (For t ε \overline{A} define t ε \overline{A} arbitrarily.) Finally, as before S denote the set of open fare products in interval t. The likelihood function is then

$${\prod }_{t ε D} {[ λ \frac{{e}^{{β}^{T} {x}_{j ( t )}}}{{\sum }_{j ε S} {e}^{{β}^{T} {x}_{j}} + 1} ]}^{{α}_{t}} {( 1 - λ )}^{1 - {a}_{t}}$$

Taking logs, we obtain the log-likelihood function

$$ℒ = {\sum }_{t ε D} [ {a}_{t} ( {B}^{T} {x}_{j ( t )} - ln ( {e}^{{β}^{T} {x}_{j}} + 1 ) ) + {a}_{t} ln ( λ ) + ( 1 - {a}_{t} ) ln ( 1 - λ )$$

Note that ζ is separable in β and λ. Maximizing ζ with respect to λ, we obtain the estimate

$${λ}^{̑} = \frac{1}{\vert D \vert} {\sum }_{t ∈ D} {a}_{t} = \frac{\vert A \vert}{\vert D \vert}$$

where |D| (resp. |A|) denotes the cardinality of D (resp. |A|). The MLE, \hat{β} is then determined by solving

$${max}_{β} {\sum }_{t ∈ A} ( {β}^{T} {x}_{j ( t )} - ln ( {\sum }_{j ∈ S} {ⅇ}^{{β}^{T} {x}_{j}} + 1 ) )$$

This is simply the usual maximum likelihood problem for the MNL applied to those periods with customer arrivals. Combining these two estimates gives the MLE for the MNL choice model with complete data.

As mentioned, the difficulty with this approach in practice is that one rarely observes all arrivals. Typically, only purchase transaction data are available. Thus, it is impossible to distinguish a period without an arrival, from a period in which there was an arrival but the arriving customer did not purchase. With this incompleteness in the data, the above MLE procedure cannot be used.

One can write down the ML formula for estimating the discrete-choice parameters with incomplete data, but as often happens in such cases, the function becomes very complex (and non-concave) and difficult to maximize. To overcome this problem, use the expectation-maximization (EM) method applied to the choice model revenue management problem.

The method works by starting with arbitrary initial estimates, \hat{β} and \hat{λ}. These estimates are then used to compute the conditional expected value of ζ: E[ζ|\hat{β}, \hat{λ}] (the expectation step). The resulting expected log-likelihood function is then maximized to generate new estimates \hat{β} and \hat{λ} (the maximization step) and the procedure is repeated until it converges. While it is true that technical convergence problems can arise, in practice the EM method is a robust and efficient way to compute maximum likelihood estimates for incomplete data.

To apply the EM method in our case, let P denote the set of periods in which customers purchase and \overline{P}=D−P denote period in which there are no purchase transactions. We can then write the complete log-likelihood function as

$$ℒ = {\sum }_{t ∈ P} [ ln ( λ ) + {β}^{T} {x}_{j ( t )} - ln ( {\sum }_{j ∈ S} {ⅇ}^{{β}^{T} {x}_{j}} + 1 ) ] + {\sum }_{t ∈ \overline{P}} [ {a}_{t} ( ln ( λ ) - ln ( {\sum }_{j ∈ S} {ⅇ}^{{β}^{T} {x}_{j}} + 1 ) ) + ( 1 - {a}_{t} ) ln ( 1 - λ ) ]$$

The unknown data are the values aₜ,t ε \overline{P} in the second sum. Given estimates \hat{β} and \hat{λ}, we determine their expected values (denoted âₜ) via Bayes's rule:

$$\begin{matrix}{{a}^{̑}}_{t} ≡ E [ {a}_{t} \vert t ∈ \overline{P} , {β}^{̑} , {λ}^{̑} ] = P ( {a}_{t} = 1 \vert t ∈ \overline{P} , {β}^{̑} , {λ}^{̑} ) \\ = \frac{P ( t ∈ \overline{P} \vert {a}_{t} = 1 , {β}^{̑} , {λ}^{̑} ) P ( {a}_{t} = 1 \vert {β}^{̑} , {λ}^{̑} )}{P ( t ∈ \overline{P} \vert {β}^{̑} , {λ}^{̑} )} \\ = \frac{{λ}^{̑} {P}_{0} ( S \vert {β}^{̑} )}{{λ}^{̑} {P}_{0} ( S \vert {β}^{̑} ) + ( 1 - {λ}^{̑} )} \\ where \\ {P}_{0} ( S \vert {β}^{̑} ) = \frac{1}{{\sum }_{j ∈ S} {ⅇ}^{{{β}^{̑}}^{T} {x}_{j}} + 1}\end{matrix}$$

is the no-purchase probability for observation t given \hat{β}.

Substituting âₜ into the complete log likelihood function, we obtain the expected log-likelihood for the incomplete data

$$E [ ℒ \vert {β}^{̑} , {λ}^{̑} ] = {\sum }_{t ∈ P} [ {β}^{T} {x}_{j ( t )} - ln ( {\sum }_{j ∈ S} {ⅇ}^{{β}^{T} {x}_{j}} + 1 ) ] - {\sum }_{t ∈ \overline{P}} {{a}^{̑}}_{t} ln ( {\sum }_{j ∈ S} {ⅇ}^{{β}^{T} {x}_{j}} + 1 ) + {\sum }_{t ∈ P} ln ( λ ) + {\sum }_{t ∈ \overline{P}} {{a}^{̑}}_{t} ln ( λ ) + ( 1 - {{a}^{̑}}_{t} ) ln ( 1 - λ ) )$$

As in the case of the complete log-likelihood function, this function is separable in \hat{β} and \hat{λ}, Maximizing with respect to λ, we obtain the updated estimate

$${λ}^{*} = \frac{\vert P \vert + {\sum }_{t ∈ \overline{P}} {{a}^{̑}}_{t}}{\vert P \vert + \vert \overline{P} \vert}$$

Our estimate of lambda is the number of observed arrivals, |P|, plus the estimated number of arrivals from unobservable periods,

$${\sum }_{t ∈ \overline{P}} {{a}^{̑}}_{t} ,$$

divided by the total number of periods |P|+|\overline{P}|=|D|.

We can then maximize the first two sums in the incomplete log-likelihood function to obtain the updated estimate β*. Note that this expression is of the same functional form as the complete data case. The entire procedure is then repeated.

Summarizing the Estimation Algorithm:

1) Initialize \hat{β} and \hat{λ}.

2) Expectation step

For t ε \overline{P} use the current estimates \hat{β} and \hat{λ}to compute âₜ.

3) Maximization step

Compute λ*

Compute β* by solving

$${max}_{β} \{ {\sum }_{t ∈ P} ( {β}^{T} {x}_{j ( t )} - ln ( {\sum }_{j ∈ S} {ⅇ}^{{β}^{T} {x}_{j}} + 1 ) ) - {\sum }_{t ∈ \overline{P}} {{a}^{̑}}_{t} ln ( {\sum }_{j ∈ S} {ⅇ}^{{β}^{T} {x}_{j}} + 1 ) \}$$

4) Convergence test

IF∥(\hat{λ},\hat{β})−(λ* , β*)∥<E, THEN STOP;

ELSE \hat{λ}←λ*,\hat{β}←β* and GOTO Step 1.

The estimation algorithm by itself would give price sensitivity and sensitivity to different product attributes. It can also be modified to account for unaccountable segment membership, with each segment having different price sensitivities. The price sensitivities can be used to set the optimal prices.

Although the invention has been disclosed in terms of a number of preferred embodiments, it will be understood that numerous variations and modifications could be made thereto without departing from the scope of the invention as defined in the following claims.

1. A computer implemented revenue management method for managing allocation of a resource, comprising the steps of:
a) providing a discrete choice model of consumer demand which models consumer preferences for a plurality of units of a resource based on known information, including historical choices and information relating to attributes of said units,
b) generating a plurality of control values using said model; and
c) applying said control values to a resource management controlling system which, using said values, defines a set of choices of said units to be offered for sale to consumers and attributes of said units.

2. The method of claim 1, wherein said step of generating a plurality of control values further includes the steps of estimating non-observable no-purchase data from said known information, and correcting for said non-observable no-purchase data in said model prior to generating said control values.

3. The method of claim 2, wherein said step of generating a plurality of control values further includes applying an optimization algorithm to said control values to generate optimized control values.

4. The method of claim 1, wherein said step of generating a plurality of control values further includes applying an optimization algorithm to said control values to generate optimize d control values.

5. The method of claim 1, wherein said resource comprises an item selected from the group comprising seats on a means of transportation for a trip to a selected destination, cargo space on a means of transportation for a trip to a selected destination, advertising time slots, tickets to facilities for at least one scheduled event, tickets to facilities for the resources of a manufacturing facility, products sold at a retail location or via electronic commerce, and energy products.

6. A computer implemented method for managing pricing of a resource, comprising the steps of:
a) providing a discrete choice model of consumer demand which models consumer preferences for a plurality of units of a resource based on known information, including historical choices and information relating to attributes of said units, said attributes including price of said units;
b) estimating non-observable no-purchase data from said known information; and
c) generating price/demand relationships using said model and correcting for said non-observable no-purchase data.

7. The method of claim 6, wherein said resource comprises an item selected from the group comprising seats on a means of transportation for a trip to a selected destination, cargo space on a means of transportation for a trip to a selected destination, advertising time slots, tickets to facilities for at least one scheduled event, tickets to facilities for the resources of a manufacturing facility, products sold at a retail location or via electronic commerce, and energy products.
